(19) United States
(12) Patent Application Publication
(10) Pub. No.: US 2024/0352378 A1
(43) Pub. Date: Oct. 24, 2024

(54) Concentrated Detergent or Cleaning Agent

(71) Applicant: Henkel AG & Co. KGaA, Duesseldorf (DE)

(72) Inventors: Niklas Matzeit, Bergheim (DE); Mareile Job, Leverkusen (DE); Anna Klemmer, Duesseldorf (DE); Anna-Carina Kluckow, Duesseldorf (DE); Matthias Sunder, Duesseldorf (DE)

(73) Assignee: Henkel AG & Co. KGaA, Duesseldorf (DE)

(21) Appl. No.: 18/638,924

(22) Filed: Apr. 18, 2024

(30) Foreign Application Priority Data
Apr. 18, 2023 (DE) 102023203482.4

(51) Int. Cl. C11D 1/18; C11D 1/24; C11D 1/83; C11D 3/386

(52) U.S. Cl. CPC C11D 1/18; C11D 1/24; C11D 1/83; C11D 3/386; C11D 2111/14

(57) ABSTRACT

Disclosed is a detergent preparation that contains, based on the total weight thereof,
a) 20 to 50 wt. % of a mixture of alkanolamine-C8-18-alkylbenzene sulfonate and sodium-C8-18-alkylbenzene sulfonate;
b) 20 to 40 wt. % non-ionic surfactant; and
c) 0.2 to 12 wt. % enzyme preparation.

Also disclosed are detergent supply forms containing this detergent preparation, method for cleaning textiles using this detergent preparation and method for the production thereof.

### FIELD OF THE INVENTION

The patent application relates to a surfactant-based highly concentrated detergent preparation. Furthermore, the application relates to detergent portion units which comprise this detergent preparation, and to a method for washing textiles using the detergent preparation or the detergent portion unit.

### BACKGROUND OF THE INVENTION

Continuously changing requirements are placed on the forms of manufacture and supply of washing and cleaning agents. The main focus has, for quite some time, been on the convenient dosing of detergents and cleaning agents by the consumer and the simplification of the work steps necessary for carrying out a washing or cleaning method. A technical solution is provided by pre-portioned detergents or cleaning agents, for example film pouches comprising one or more receiving chambers for solid or liquid detergents or cleaning agents. A further solution provides containers from which the detergents and cleaning agents can be dosed in a simple and controlled manner.

A trend relevant to the production of these film pouches is the miniaturization of these film pouches by increased concentration of the detergents. The background of this development is higher consumer acceptance due to simplified handling, in particular sustainability aspects, for example in relation to transport volumes and costs and the quantity of packaging materials used. A comparable tendency for concentration and miniaturization also relates to the field of the storage and dosing containers for detergents.

The concentration of modern detergents, in particular modern liquid detergents, generally influences their optical and rheological properties and also affects the storage stability of these agents, in particular in the case of storage under stress conditions, that is to say lower than average or above-average temperatures.

In order to improve the storage properties of concentrated liquid formulations, German patent application DE 31 32 219 A1 proposes the use of surfactant mixtures based on sulfobetaines and quaternary ammonium alkene sulfonates. The German patent application DE 100 27 674 A1 describes the use of glyceride alkoxylates for production at low temperatures of stable liquid detergents.

In the European Patent EP 2 864 465 B1, concentrated liquid detergents to be packaged in water-soluble portion pouches are described. The liquid detergents are based on a mixture of alkylbenzene sulfonic acid, ethoxylated fatty alcohols, and alkylamines. The liquid detergents described in this patent are in need of improvement with regard to their storage capacity, their filling behavior and dosing capability from storage containers, as well as their washing and cleaning performance.

### BRIEF SUMMARY OF THE INVENTION

The object addressed by the application was that of providing visually appealing, concentrated detergents or cleaning agents which can be produced in a simple and efficient manner, have good cleaning performance with low dosing quantity and are optically, rheologically and chemically stable under demanding storage conditions. The detergents or cleaning agents should furthermore have good filling capability and good dosing behavior from storage containers and have a good cleaning level in the case of small usage amounts.

### DETAILED DESCRIPTION OF THE INVENTION

A first subject matter of the application is a detergent preparation comprising, based on the total weight thereof,
a) 20 to 50 wt. % a mixture of alkanolamine-C₈₋₁₈-alkylbenzene sulfonate and sodium-C₈₋₁₈-alkylbenzene sulfonate;
b) 20 to 40 wt. % non-ionic surfactant;
c) 0.2 to 12 wt. % enzyme preparation.

The detergent preparation contains as its first essential constituent a mixture of alkanolamine-C₈₋₁₈-alkylbenzene sulfonate and sodium-C₈₋₁₈-alkylbenzene sulfonate. It has been found that the use of a corresponding mixture in these weight fractions is suitable for advantageously influencing the optical properties and the storage stability and the filling and dosing behavior of the detergent preparation.

It has proven to be particularly advantageous in this context if the detergent preparation contains, based on the total weight thereof, 24 to 45 wt. %, preferably 28 to 40 wt. % anionic surfactant, comprising alkanolamine-C₈₋₁₈-alkylbenzene sulfonate and sodium-C₈₋₁₈-alkylbenzene sulfonate.

For the aforementioned product properties, as well as for the washing performance of the detergent preparation, it has proven to be sufficient that the detergent preparation contains, in addition to the anionic surfactant from the group of alkanolamine-C₈₋₁₈-alkylbenzene sulfonates and sodium-C₈₋₁₈-alkylbenzene sulfonates, based on the total weight thereof, less than 10 wt. %, preferably less than 6 wt. %, in particular less than 2 wt. %, and in particular no further anionic surfactant(s). Dispensing with further anionic surfactants also reduces the complexity of the detergent formulation and its production.

For further increasing the storage, filling and dosing properties, preferred detergent preparations contain a mixture of alkanolamine-C₈₋₁₈-alkylbenzene sulfonate and sodium-C₈₋₁₈-alkylbenzene sulfonate in a weight ratio of from 10:1 to 1:4, preferably from 7:1 to 1:2, particularly preferably from 4:1 to 1:1, and in particular from 7:2 to 5:2.

The alkanolamine-C₈₋₁₈-alkylbenzene sulfonate preferably comprises an alkanolamine from the group of monoethanolamine, monoisopropanolamine, diisopropanolamine, in particular from the group of monoisopropanolamine. These sulfonates are characterized by advantageous rheological properties, including good storage, filling and dosing behavior, compared to the salts of other amines or alkanolamines.

The detergent preparation can contain fatty acid alkanolamine salt as a further component. Fatty acids and salts thereof are not assigned to the anionic surfactants within the scope of this application. The proportion by weight of the fatty acid alkanolamine salt with respect to the total weight of the detergent preparation is, based on the total weight thereof, preferably 4 to 18 wt. % and particularly preferably 6 to 16 wt. % fatty acid alkanolamine salt.

Particularly preferred fatty acids are selected from the group of myristic acid, palmitic acid, stearic acid, oleic acid, linoleic acid and mixtures thereof. The fatty acid alkanolamine salt preferably comprises an alkanolamine from the group of monoethanolamine, monoisopropanolamine, diisopropanolamine, particularly preferably from the group of monoisopropanolamine.

A second essential component of the detergent preparation is the non-ionic surfactant. The proportion by weight of the non-ionic surfactant with respect to the total weight of the detergent preparation is preferably 22 to 38 wt. % and particularly preferably 24 to 36 wt. %.

Particularly preferred is the use of non-ionic surfactants from the group of the ethoxylated primary C₆₋₁₈ alcohols, preferably the ethoxylated primary C₆₋₁₈ alcohols having a degree of alkoxylation ≥2, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.

With regard to the rheological properties of the detergent preparation, the filling and dosing capability and washing effect thereof, it has proven advantageous to use anionic surfactant and non-ionic surfactant in a weight ratio of from 3:2 to 2:3, preferably from 4:3 to 1:1.

A third significant component of the detergent preparation is the enzyme preparation, whose proportion by weight with respect to the total weight of the detergent preparation is 0.2 to 12 wt. %, preferably 0.5 to 10 wt. % and in particular 2 to 8 wt. %.

In addition to the actual enzyme protein, an enzyme preparation comprises further components such as enzyme stabilizers, carrier materials or fillers. In this case, the enzyme protein typically forms only a fraction of the total weight of the enzyme preparation. Enzyme preparations which are preferably used contain between 0.1 and 40 wt. %, preferably between 0.2 and 30 wt. %, more preferably between 0.4 and 20 wt. %, and most preferably between 0.8 and 10 wt. % of the enzyme protein. In such compositions, an enzyme stabilizer can be contained in an amount of 0.05 to 35 wt. %, preferably 0.05 to 10 wt. %, based on the total weight in the enzyme composition.

The protein concentration can be determined using known methods, for example the BCA method (bicinchoninic acid; 2,2′-bichinolyl-4,4′-dicarboxylic acid) or the Biuret method. The active protein concentration is determined in this regard via titration of the active centers using a suitable irreversible inhibitor (for proteases, for example, phenylmethylsulfonylfluoride (PMSF)), and determination of the residual activity.

It is preferred if the detergent preparation contains at least one enzyme preparation, preferably at least 3 enzyme preparations of enzymes from the group of protease, amylase, mannanase, cellulase, lipase, β-hexosaminidase, preparations of a pectinolytic enzyme and endoglucanase.

It is preferred according to the invention if at least one protease is contained in the detergent preparation as the enzyme. A protease is an enzyme that cleaves peptide bonds by hydrolysis. Each of the enzymes from class E.C. 3.4 according to the invention falls thereunder (comprising each of the thirteen subclasses which fall thereunder). According to the invention, “protease activity” is present if the enzyme has proteolytic activity (EC 3.4). Different types of protease-activity are known: The three main types are: trypsin-like, where the amide substrate is cleaved following the amino acids Arg or Lys at P1; chymotrypsin-like, where cleavage takes place following one of the hydrophobic amino acids at P1; and elastase-like, where the amide substrate is cleaved following Ala at P1.

The proportion by weight of the protease preparation with respect to the total weight of the detergent preparation is preferably 0.5 to 7 wt. % and in particular 1 to 5 wt. %.

The detergent preparation preferably contains at least one amylase, in particular an α-amylase. α-amylases (E.C. 3.2.1.1) hydrolyze as α-1,4-glycosidic bonds of starch and starch-like polymers which are internal to enzymes. By way of example, α-amylases from Bacillus licheniformis, from B. amyloliquefaciens and from B. stearothermophilus, as well as the developments thereof that have been improved for use in detergents or cleaning agents, may be mentioned. The enzyme from B. licheniformis is available from the company Novozymes under the trade name Termamyl® and from the company Genencor under the trade name Purastar®ST. Development products of these α-amylases are available from Novozymes under the trade names Duramyl® and Termamyl®ultra, from Genencor under the name Purastar®OxAm, and from Daiwa Seiko Inc., Tokyo, Japan, as Keistase®. The α-amylase from B. amyloliquefaciens is marketed by Novozymes under the name BAN®, and derived variants of the α-amylase from B. stearothermophilus are marketed under the names BSG® and Novamyl®, also by Novozymes. Examples for α-amylases from other organisms are the developments of α-amylase from Aspergillus niger and A. oryzae that are available under the trade name Fungamyl® from Novozymes.

The proportion by weight of the amylase preparation, in particular the α-amylase preparation, with respect to the total weight of the detergent preparation is preferably 0.05 to 2 wt. %, in particular 0.1 to 1 wt. %.

As a preferred component, the detergent preparation contains, with respect to the total weight thereof, 0.05 to 2 wt. %, preferably 0.1 to 1 wt. %, of a mannanase preparation.

A mannanase catalyzes the hydrolysis of 1,4-beta-D-mannosidic bonds in mannans, galactomannans, glucomannans and galactoglucomannans. Said mannanases are classified according to the enzyme nomenclature as E.C. 3.2.1.78.

As a further preferred optional component, the detergent preparations contain a cellulase preparation. Synonymous terms can be used for cellulases, in particular endoglucanase, endo-1,4-beta-glucanase, carboxymethyl cellulase, endo-1,4-beta-D-glucanase, beta-1,4-glucanase, beta-1,4-endoglucanhydrolase, celludextrinase or avicelase. Within the meaning of the invention, whether or not an enzyme is a cellulase is decided by its ability to hydrolyze 1,4-β-D-glucosidic bonds in cellulose.

Cellulases (endoglucanases, EG) suitable according to the invention include, for example, fungal compositions rich in endoglucanase (EG), which are provided by the company Novozymes under the trade name Celluzyme®. The products Endolase® and Carezyme®, also available from Novozymes, are based on 50 kD-EG and 43 kD-EG, respectively, from Humicola insolens DSM 1800. Further commercial products from this company that can be used are Cellusoft®, Renozyme®, and Celluclean®. It is also possible to use cellulases, for example, which are available from AB Enzymes, Finland, under the trade names Ecostone® and Biotouch®, and which are, at least in part, based on 20 kD-EG from Melanocarpus. Further cellulases from AB Enzymes are Econase® and Ecopulp®. Further suitable cellulases are from Bacillus sp. CBS 670.93 and CBS 669.93, wherein the cellulase from Bacillus sp. CBS 670.93 is available from Danisco/Genencor under the trade name Puradax®. Other commercial products from Danisco/Genencor that can be used are “Genencor detergent cellulase L” and IndiAge®Neutra.

The proportion by weight of the cellulase preparation with respect to the total weight of the detergent preparation is preferably 0.05 to 2 wt. %, particularly preferably 0.1 to 1 wt. %.

With respect to the cleaning performance thereof, advantageous detergent preparations contain, based on the total weight thereof, preferably from 0.01 to 5 wt. %, preferably from 0.1 to 4 wt. %, and in particular from 0.15 to 2.5 wt. % hexosaminidase preparation.

The term “hexosaminidase” denotes a polypeptide with hexosaminidase activity (hexosaminidases) and includes enzymes which catalyze the hydrolysis of N-acetyl-D-hexosamine- or N-acetylglucosamine polymers.

Polypeptides with hexosaminidase activity include dispersins, such as Dispersin B (DspB), which are β-N-acetylglucosamininidases belonging to the glycoside hydrolase 20 family. Dispersins are produced by the parodontal pathogen Aggregatibacter actinomycetemcomitans, a gram-negative oral bacterium. Dispersin B is a β-hexosaminidase, which specifically hydrolyzes β-1,6-glycosidic bonds of acetylglucosamine polymers. The use of hexosaminidases from the group of β-hexosaminidases is preferred.

Preferred detergent preparations contain as an optional component, based on their total weight, from 0.05 to 2 wt. %, preferably from 0.1 to 0.4 wt. %, of a preparation of a pectinolytic enzyme.

In the context of the present invention, the pectinolytic enzymes include enzymes having the names pectinase, pectate lyase, pectin esterase, pectin demethoxylase, pectin methoxylase, pectin methylesterase, pectase, pectin methylesterase, pectinesterase, pectin pectyl hydrolase, pectin depolymerase, endopolygalacturonase, pectolase, pectin hydrolase, pectin polygalacturonase, 20 endopolygalacturonase, poly-α-1,4-galacturonide, glycanohydrolase, endogalacturonase, endo-D-galacturonase, galacturan 1,4-α-galacturonidase, exopolygalacturonase, poly(galacturonate) hydrolase, exo-D-galacturonase, exo-D-galacturonanase, exopoly-D-galacturonase, exo-poly-α-galacturonosidase, exopolygalacturonosidase, or 25 exopolygalacturanosidase. The use of pectin lyases is very particularly preferred here.

Within the EC classification of enzymes, the numerical classification system for enzymes, the pectinolytic enzymes belong in particular to the enzyme classes (“Enzyme Commission number”) EC 3.1.1.11, EC 3.2.1.15, EC 3.2.1.67 and EC 3.2.1.82 and consequently belong to the third of the six main enzyme classes, the 10 hydrolases (E.C.3. hereunder to the glycosylases (E.C. 3.2.-.-) and again hereunder to the glycosidases (EC 3.2.1.-), i.e., enzymes which hydrolyze O— and/or S-glycosyl compounds. Consequently, pectinolytic enzymes act in particular against residues on dishes which contain pectic acid and/or other galacturonans, and catalyze the hydrolysis thereof.

In the context of the invention, pectate lyases are enzymes which catalyze the non-hydrolytic cleavage of pectate according to an endo mechanism.

Examples of suitable pectinolytic enzymes are the enzymes and enzyme preparations available under the trade names Gamanase®, Pektinex AR®, X-Pect® or Pectaway® from Novozymes, under the trade names Rohapect UF®, Rohapect TPL®, Rohapect PTE100®, Rohapect MPE®, 30 Rohapect MA plus HC, Rohapect DA12L®, Rohapect 10L®, Rohapect B1 L® from AB Enzymes, and under the trade name Pyrolase® from Diversa Corp., San Diego, CA, USA.

As stated at the outset, the detergent preparations have a high concentration, i.e., have a high proportion by weight, of washing-active ingredients and a small amount of fillers and auxiliaries or solvents.

Therefore, preferred detergent preparations contain, based on the total weight thereof, less than 6 wt. %, preferably less than 4 wt. %, particularly preferably less than 1 wt. % and in particular no organic solvents. The group of organic solvents includes, for example, ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxyethoxy-2-propanol, 3-methyl-3-methoxybutanol, propylene-glycol-t-butylether, di-n-octylether, and mixtures thereof. The alkanolamines described at the outset as a component of alkanolamine-C8-18-alkylbenzene sulfonates and the fatty acid alkanolamine salts are not assigned to the organic solvents in this context.

Furthermore, preferred detergent preparations contain, based on the total weight thereof, less than 6 wt. %, preferably less than 3 wt. %, particularly preferably less than 1 wt. % and in particular no water.

The detergent preparation contains a phosphonate as a preferred optional component.

The proportion by weight of the phosponate with respect to the total weight of the detergent preparation is preferably from 0.2 to 10 wt. %, more preferably from 0.5 to 8 wt. % and in particular from 1.0 to 6 wt. %.

A phosphonate from the group of hydroxyalkane phosphonates and/or aminoalkane phosphonates, preferably from the group of aminoalkane phosphonates, and in particular from the group of ethylenediamine tetramethylene phosphonate (EDTMP) and diethylenetriamine pentamethylene phosphonate (DTPMP), in particular from the group diethylenetriamine pentamethylene phosphonate (DTPMP), is preferably as the phosphonate compound.

As a preferred optional component, the detergent composition furthermore contains washing-active polymer. The proportion by weight of the washing-active polymer with respect to the total weight of the detergent composition is preferably 1 to 18 wt. % and in particular 4 to 15 wt. %. The washing-active polymer can belong to different substance classes. Washing-active polymers of a substance class, but preferably washing-active polymers of different substance classes, can be used.

A first preferred substance class of washing-active polymers is formed by the polyalkoxylated polyalkyleneimines, which are obtained by reacting polyalkyleneimines with alkylene oxides. As a result of their washing performance, particularly preferred detergent preparations contain, based on the total weight thereof, polyalkoxylated polyalkyleneimine, which is obtained by reacting polyalkyleneimines with alkylene oxides in amounts of 0.5 to 7 wt. %, preferably 1.0 to 6 wt. %, and in particular 2.5 to 5 wt. %.

The polyalkoxylated polyalkyleneimine is a polymer having a polyalkyleneimine backbone which carries polyalkoxy groups on the N atoms. It preferably has a weight-average molecular weight Mw in the range from 5000 g/mol to 60000 g/mol, in particular from 10000 g/mol to 22500 g/mol. The polyalkyleneimine has primary amino functions at the ends and preferably both secondary and tertiary amino functions in the interior, and optionally it can also have only secondary amino functions in the interior, such that the result is not a branched-chain but a linear polyalkyleneimine. The ratio of primary to secondary amino groups in the polyalkyleneimine is preferably in the range from 1:0.5 to 1:1.5, in particular in the range from 1:0.7 to 1:1. The ratio of primary to tertiary amino groups in the polyalkyleneimine is preferably in the range from 1:0.2 to 1:1, in particular in the range from 1:0.5 to 1:0.8. The polyalkyleneimine preferably has a weight-average molecular weight in the range from 500 g/mol to 50,000 g/mol, in particular from 550 g/mol to 2,000 g/mol. The N atoms in the polyalkyleneimine are preferably separated from one another by alkylene groups having 2 to 12 C atoms, in particular 2 to 6 C atoms, although it is not necessary for all the alkylene groups to have the same number of C atoms. Ethylene groups, 1,2-propylene groups, 1,3-propylene groups and mixtures thereof are particularly preferred. The primary amino functions in the polyalkyleneimine can carry 1 or 2 polyalkoxy groups and the secondary amino functions can carry 1 polyalkoxy group, not every amino function having to be alkoxy group-substituted. The average number of alkoxy groups per primary and secondary amino function in the polyalkoxylated polyalkylenimine is preferably 5 to 100, in particular 10 to 50. The alkoxy groups in the polyalkoxylated polyalkylene imine are preferably ethoxy, propoxy or butoxy groups or mixtures thereof. Polyethoxylated polyethyleneimines are particularly preferred. The polyalkoxylated polyalkyleneimines are obtained by reacting the polyalkyleneimines with epoxides corresponding to the alkoxy groups. If desired, the terminal OH function of at least some of the polyalkoxy substituents can be replaced by an alkyl ether function having 1 to 10, in particular 1 to 3, C atoms.

A further preferred substance class of washing-active polymers is formed by the polyalkoxylated amines having a weight-average molecular weight Mw in the range from 600 g/mol to 10,000 g/mol, which are obtained by reacting ammonia or primary alkylamines or hydroxyalkylamines having a molecular weight of less than 200 g/mol with alkylene oxides. Preferred detergent compositions contain the polyalkoxylated amine, relative to the total weight thereof, in weight fractions of from 0.5 to 10 wt. %, preferably from 1 to 9 wt. % and in particular from 1.5 to 7.5 wt. %.

Preferred polyalkoxylated amines have a weight-average molecular weight Mw in the range from 1,300 g/mol to 6,000 g/mol, in particular from 1,400 g/mol to 4,500 g/mol. (The average molecular weights indicated here, and later optionally for other polymers, are weight-average molecular weights Mw which can in principle be determined by means of gel permeation chromatography with the aid of an RI detector, the measurement expediently being carried out against an external standard.) For their preparation, it is possible to start, in a known manner, from ammonia, a monoalkylamine, a monoalkyl-monoalkanolamine or a monoalkyl-dialkanolamine or a mono-, di- or trialkanolamine, for example triethanolamine, methyl-, ethyl-, propyl- and isopropyl-diethanolamine, methyl-, ethyl-, propyl- and isopropyl-diisopropanolamine, tripropanolamine, triisopropanolamine, N,N-Di-(2-hydroxyethyl)cyclohexylamine, N,N-Di-(2-hydroxypropyl)cyclohexylamine, n-butylamine, n-hexylamine, n-octylamine, isopropylamine, sec-butylamine, tert-butylamine, cyclohexylamine, 2-ethylhexylamine, 2-phenylethylamine and mixtures thereof, which is reacted with an alkylene oxide, in particular selected from the group consisting of ethylene oxide, propylene oxide, butylene oxide and mixtures thereof, in particular with a mixture containing propylene oxide and preferably ethylene oxide, particularly preferably with propylene oxide. The polyalkoxylated amines thus obtained may be block or random structures. Particular preference is given, inter alia, to a polyalkoxylated amine obtained by propoxylation of triethanolamine, preferably having a length of the three side arms of 15 propylene oxide units in each case. Also preferred is a polyalkoxylated amine obtained by propoxylation of triisopropanolamine, preferably having a length of the three side arms of 15 propylene oxide units in each case. Polyalkoxylated monoalkylamines having a linear, branched or cyclic alkyl group are likewise suitable, an alkylene oxide selected from the group consisting of ethylene oxide, propylene oxide, butylene oxide and mixtures thereof being alkoxylated, preferably with a mixture comprising propylene oxide, more preferably with propylene oxide. Preference is also given to a polyalkoxylated amine obtained by propoxylation of tert-butylamine, preferably having a length of the two side arms of 12 propylene oxide units in each case.

Preferred polyalkoxylated amines satisfy the general formula (I),

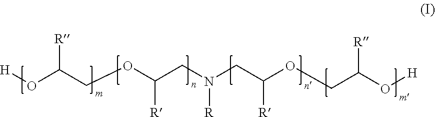

in which R represents a linear, optionally branched or optionally cyclic alkyl group having
1 to 12 C atoms, or a group —(CH2CHR′O)_{n″}(CH₂CHR″O)_{m″}—H,
R′ and R″, independently of one another, represent H, CH₃ or CH₂CH₃,
n, n′ and n″, independently of one another, represent numbers from 0 to 30, preferably from 0 to 10 and in particular 0 to 5, and
m, m′ and m″ represent, independently of one another, numbers from 0 to 30, preferably from 5 to 20 and in particular from 12 to 16,
with the proviso that the sum n+n′+n″+m+m′+m″ is at least 14, preferably in the range of from 18 to 100 and in particular in the range of from 20 to 70. Preferably, in the compounds of the formula I, at least one of the functional groups R′ and R″ is a CH₃ group.

A detergent preparation which contains washing-active polymer from the group of polyalkoxylated amines, which are obtained by ethoxylation and subsequent propoxylation of triethanolamine, are particularly preferred.

A third group of preferred washing-active polymers is formed by the alcohol polyalkoxylates having a weight-average molecular weight MW in the range of from 600 g/mol to 10,000 g/mol, which are obtained by reacting diols or triols with primary and/or secondary OH groups, which have a molecular weight MW in the range of from 60 g/mol to 200 g/mol, with alkylene oxides.

Preferred alcohol polyalkoxylates have a weight-average molecular weight Mw in the range of from 1,300 g/mol to 6,000 g/mol, in particular from 1,400 g/mol to 4,500 g/mol. For the preparation of said alcohol polyalkoxylates, it is possible to start in a known manner from a diol or triol having a molecular weight preferably in the range of from 70 g/mol to 150 g/mol, which is reacted, in particular under alkaline conditions, with an alkylene oxide, in particular selected from the group consisting of ethylene oxide, propylene oxide, butylene oxide and mixtures thereof, in particular is reacted with a mixture containing propylene oxide and preferably ethylene oxide, particularly preferably is reacted with propylene oxide. The polyalkoxylated diols or triols obtained in this way can be block or random structures. In a preferred embodiment of the present invention, the diol or triol is a cyclic diol or cyclic triol or glycerol, ethylene glycol, 1,2-propanediol, trimethylolpropane, butanediol, 1,1,1-tris(hydroxymethyl)ethane, or a mixture of at least two of these.

Preferred alcohol polyalkoxylates satisfy the general formula (II)

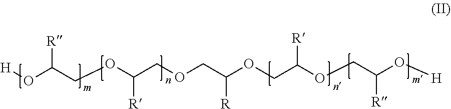

in which R represents a linear, in some cases branched or in some cases cyclic alkyl group having 1 to 12 C atoms, or a group —(CH₂CHR′O)_{n″}—(CH₂CHR″O)_{m″}—H,
R′ and R″ represent, independently of one another, H, CH₃ or CH₂CH₃,
n, n′ and n″ represent, independently of one another, numbers from 0 to 30, preferably from 0 to 10 and in particular 0 to 5, and
m, m′ and m″ represent, independently of one another, numbers from 0 to 30, preferably from 5 to 20 and in particular from 12 to 16,
with the proviso that the sum n+n′+n″+m+m′+m″ is at least 14, preferably in the range of from 18 to 100 and in particular in the range of from 20 to 70.

Particularly preferred is the use of an alcohol polyalkoxylate from the group of polypropylene glycols.

The ethylene oxide propylene oxide ethylene oxide triblock copolymers in which the copolymer comprises a first EO block, a second EO block and a PO block, wherein the first EO block and the second EO block are connected to the PO block, form a further group of preferred washing-active polymers.

The ethylene oxide propylene oxide ethylene oxide (EO/PO/EO) triblock copolymer preferably has an average propylene oxide chain length between 15 and 70, preferably between 20 and 60, more preferably between 25 and 50, even more preferably between 25 and 40, most preferably between 25 and 35 propylene oxide units.

The average molecular weight of the ethylene oxide propylene oxide ethylene oxide (EO/PO/EO) triblock copolymer is preferably between 1,000 and 10,000, preferably between 1,500 and 5,000, more preferably between 2,000 and 4,500, even more preferably between 2,500 and 4,000, most preferably between 2,500 and 3,000.

Each ethylene oxide chain of the ethylene oxide propylene oxide ethylene oxide triblock copolymer preferably has an average chain length between 2 and 90, preferably between 3 and 50, more preferably between 4 and 20, even more preferably between 5 and 15, most preferably between 10 and 15 ethylene oxide units.

The ethylene oxide propylene oxide ethylene oxide triblock copolymer comprises on average between 10 wt. % and 90 wt. %, preferably between 20 wt. % and 70 wt. %, most preferably between 30 wt. % and 50 wt. % of the copolymer, of the combined ethylene oxide blocks, wherein more preferably the total ethylene oxide content is distributed over the two ethylene oxide blocks, so that each ethylene oxide block comprises on average between 40% and 60%, preferably between 45% and 55%, even more preferably between 48% and 52%, most preferably 50% of the total number of ethylene oxide units, wherein the percentage of both ethylene oxide blocks together makes up 100% of the ethylene oxide units present.

Preferred detergent preparations contain an ethylene oxide propylene oxide ethylene oxide triblock copolymer having an average molecular weight between 2500 and 3000, an average propylene oxide content between 25 and 35 propylene oxide units and an average ethylene oxide content between 10 and 15 ethylene oxide units per ethylene oxide block.

As a further optional component, a preferred detergent preparation, based on the total weight thereof, comprises 0.2 to 4 wt. %, preferably 0.5 to 3 wt. %, fragrance preparation.

In addition to the actual fragrances, the fragrance preparation comprises solvents, solid carrier materials or stabilizers, for example.

A fragrance is a chemical substance that stimulates the sense of smell. In order to be able to stimulate the sense of smell, the chemical substance should be able to be distributed in the air, at least in part, i.e., the fragrance should be volatile at 25° C., at least to a small degree. If the fragrance is very volatile, the odor intensity then decreases rapidly again. In the case of a lower volatility, however, the odor impression is more sustainable, i.e., it does not disappear as quickly. In one embodiment, the fragrance therefore has a melting point which is in the range from −100° C. to 100° C., preferably from −80° C. to 80° C., more preferably from −20° C. to 50° C., in particular from −30° C. to 20° C. In a further embodiment, the fragrance has a boiling point in the range from 25° C. to 400° C., preferably from 50° C. to 380° C., more preferably from 75° C. to 350° C., in particular from 100° C. to 330° C.

Overall, a chemical substance should not exceed a particular molecular mass in order to act as a fragrance, since the required volatility can no longer be ensured at too high a molecular mass. In one embodiment, the fragrance has a molecular mass of 40 to 700 g/mol, more preferably of 60 to 400 g/mol.

The odor of a fragrance is perceived as pleasant by most people, and frequently corresponds to the odor of, for example, flowers, fruits, spices, bark, resin, leaves, grasses, mosses and roots. Thus, fragrances can also be used to mask unpleasant odors or else to provide a non-smelling substance with a desired odor. Individual fragrance compounds, for example the synthetic products of the ester, ether, aldehyde, ketone, alcohol and hydrocarbon types, can be used as fragrances.

Preferably, mixtures of different fragrances are used, which together produce an attractive fragrance note. Such a mixture of fragrances can also be referred to as perfume or perfume oil. Perfume oils of this kind can also contain natural fragrance mixtures, as are obtained from plant sources.

For the lengthening of the fragrance effect, it has proven advantageous to encapsulate the fragrance. In a corresponding embodiment, at least a portion of the fragrance is used in encapsulated form (fragrance capsules), in particular in microcapsules. However, the entire fragrance can also be used in encapsulated form. The microcapsules may be water-soluble and/or water-insoluble microcapsules. For example, melamine-urea-formaldehyde microcapsules, melamine-formaldehyde microcapsules, urea-formaldehyde microcapsules or starch microcapsules can be used. “Fragrance precursor” refers to compounds which release the actual fragrance only after chemical conversion/cleavage, typically by the action of light or other ambient conditions, such as pH, temperature, etc. Such compounds are often also referred to as “pro-fragrances”.

Preferred detergent preparations contain, based on their total weight, 0.01 to 0.2 wt. % dye.

The composition of some preferred detergent preparations can be found in the following tables (information in wt. % based on the total weight of the preparation, unless otherwise indicated).

| | Formula 1 | Formula 2 | Formula 3 | Formula 4 |
|---|---|---|---|---|
| Anionic surfactant ¹⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Misc. | up to 100 | up to 100 | up to 100 | up to 100 |
| | Formula 6 | Formula 7 | Formula 8 | Formula 9 |
| Anionic surfactant ²⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Misc. | up to 100 | up to 100 | up to 100 | up to 100 |
| | Formula 11 | Formula 12 | Formula 13 | Formula 14 |
| Anionic surfactant ¹⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Organic solvent | <6 | <6 | <3 | <1 |
| Water | <6 | <6 | <3 | <1 |
| Misc. | up to 100 | up to 100 | up to 100 | up to 100 |
| | Formula 16 | Formula 17 | Formula 18 | Formula 19 |
| Anionic surfactant ²⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Organic solvent | <6 | <6 | <3 | <1 |
| Water | <6 | <6 | <3 | <1 |
| Misc. | up to 100 | up to 100 | up to 100 | up to 100 |
| | Formula 21 | Formula 22 | Formula 23 | Formula 24 |
| Anionic surfactant ¹⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Washing-active polymer | 1 to 18 | 1 to 18 | 4 to 15 | 4 to 15 |
| Misc. | up to 100 | up to 100 | up to 100 | up to 100 |
| | Formula 26 | Formula 27 | Formula 28 | Formula 29 |
| Anionic surfactant ²⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Washing-active polymer | 1 to 18 | 1 to 18 | 4 to 15 | 4 to 15 |
| Misc. | up to 100 | up to 100 | up to 100 | up to 100 |
| | Formula 31 | Formula 32 | Formula 33 | Formula 34 |
| Anionic surfactant ¹⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Washing-active polymer | 1 to 18 | 1 to 18 | 4 to 15 | 4 to 15 |
| Organic solvent | <6 | <6 | <3 | <1 |
| Water | <6 | <6 | <3 | <1 |
| Misc. | up to 100 | up to 100 | up to 100 | up to 100 |
| | Formula 36 | Formula 37 | Formula 38 | Formula 39 |
| Anionic surfactant ²⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Washing-active polymer | 1 to 18 | 1 to 18 | 4 to 15 | 4 to 15 |
| Organic solvent | <6 | <6 | <3 | <1 |
| Water | <6 | <6 | <3 | <1 |
| Misc. | up to 100 | up to 100 | up to 100 | up to 100 |
| | Formula 41 | Formula 42 | Formula 43 | Formula 44 |
| Anionic surfactant ¹⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Fatty acid alkanolamine salt | 4 to 18 | 4 to 18 | 6 to 16 | 6 to 16 |
| Misc. | up to 100 | up to 100 | up to 100 | up to 100 |
| | Formula 46 | Formula 47 | Formula 48 | Formula 49 |
| Anionic surfactant ²⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Fatty acid alkanolamine salt | 4 to 18 | 4 to 18 | 6 to 16 | 6 to 16 |
| Misc. | up to 100 | up to 100 | up to 100 | up to 100 |
| | Formula 51 | Formula 52 | Formula 53 | Formula 54 |
| Anionic surfactant ¹⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Fatty acid alkanolamine salt | 4 to 18 | 4 to 18 | 6 to 16 | 6 to 16 |
| Organic solvent | <6 | <6 | <3 | <1 |
| Water | <6 | <6 | <3 | <1 |
| Misc. | up to 100 | up to 100 | up to 100 | up to 100 |
| | Formula 56 | Formula 57 | Formula 58 | Formula 59 |
| Anionic surfactant ²⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Fatty acid alkanolamine salt | 4 to 18 | 4 to 18 | 6 to 16 | 6 to 16 |
| Organic solvent | <6 | <6 | <3 | <1 |
| Water | <6 | <6 | <3 | <1 |
| Misc. | up to 100 | up to 100 | up to 100 | up to 100 |
| | Formula 61 | Formula 62 | Formula 63 | Formula 64 |
| Anionic surfactant ¹⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Phosphonate | 0.2 to 10 | 0.2 to 10 | 0.5 to 8 | 1 to 6 |
| Misc. | up to 100 | up to 100 | up to 100 | up to 100 |
| | Formula 66 | Formula 67 | Formula 68 | Formula 69 |
| Anionic surfactant ²⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Phosphonate | 0.2 to 10 | 0.2 to 10 | 0.5 to 8 | 1 to 6 |
| Misc. | up to 100 | up to 100 | up to 100 | up to 100 |
| | Formula 71 | Formula 72 | Formula 73 | Formula 74 |
| Anionic surfactant ¹⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Phosphonate | 0.2 to 10 | 0.2 to 10 | 0.5 to 8 | 1 to 6 |
| Organic solvent | <6 | <6 | <3 | <1 |
| Water | <6 | <6 | <3 | <1 |
| Misc. | up to 100 | up to 100 | up to 100 | up to 100 |
| | Formula 76 | Formula 77 | Formula 78 | Formula 79 |
| Anionic surfactant ²⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Phosphonate | 0.2 to 10 | 0.2 to 10 | 0.5 to 8 | 1 to 6 |
| Organic solvent | <6 | <6 | <3 | <1 |
| Water | <6 | <6 | <3 | <1 |
| Misc. | up to 100 | up to 100 | up to 100 | up to 100 |
| | Formula 81 | Formula 82 | Formula 83 | Formula 84 |
| Anionic surfactant ¹⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Washing-active polymer | 1 to 18 | 1 to 18 | 4 to 15 | 4 to 15 |
| Fatty acid alkanolamine salt | 4 to 18 | 4 to 18 | 6 to 16 | 6 to 16 |
| Misc. | up to 100 | up to 100 | up to 100 | up to 100 |
| | Formula 86 | Formula 87 | Formula 88 | Formula 89 |
| Anionic surfactant ²⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Washing-active polymer | 1 to 18 | 1 to 18 | 4 to 15 | 4 to 15 |
| Fatty acid alkanolamine salt | 4 to 18 | 4 to 18 | 6 to 16 | 6 to 16 |
| Misc. | up to 100 | up to 100 | up to 100 | up to 100 |
| | Formula 91 | Formula 92 | Formula 93 | Formula 94 |
| Anionic surfactant ¹⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Washing-active polymer | 1 to 18 | 1 to 18 | 4 to 15 | 4 to 15 |
| Fatty acid alkanolamine salt | 4 to 18 | 4 to 18 | 6 to 16 | 6 to 16 |
| Organic solvent | <6 | <6 | <3 | <1 |
| Water | <6 | <6 | <3 | <1 |
| Misc. | up to 100 | up to 100 | up to 100 | up to 100 |
| | Formula 96 | Formula 97 | Formula 98 | Formula 99 |
| Anionic surfactant ²⁾ | 20 to 50 | 24 to 45 | 24 to 45 | 28 to 40 |
| Non-ionic surfactant | 20 to 40 | 20 to 40 | 22 to 38 | 24 to 36 |
| Enzyme preparation | 0.2 to 12 | 0.5 to 10 | 0.5 to 10 | 2 to 8 |
| Washing-active polymer | 1 to 18 | 1 to 18 | 4 to 15 | 4 to 15 |
| Fatty acid alkanolamine salt | 4 to 18 | 4 to 18 | 6 to 16 | 6 to 16 |
| Organic solvent | <6 | <6 | <3 | <1 |
| Water | <6 | <6 | <3 | <1 |
| Misc. | up to 100 | up to 100 | up to 100 | up to 100 |

¹⁾ Mixture of alkanolamine-C₈₋₁₈-alkylbenzene sulfonate and sodium-C₈₋₁₈-alkylbenzene sulfonate
²⁾ Mixture of alkanolamine-C₈₋₁₈-alkylbenzene sulfonate and sodium-C₈₋₁₈-alkylbenzene sulfonate in a weight ratio of from 10:1 to 1:4, preferably from 7:1 to 1:2, particularly preferably from 4:1 to 1:1, and in particular from 7:2 to 5:2

The detergent preparation preferably has a viscosity (23° C., shear rate 30 sec⁻¹) from 1,500 to 10,000 mPas, preferably from 3000 to 8000 mPas, particularly preferably from 5,500 to 6,500 mPas.

The pH of the detergent preparation is preferably in the range from 6 to 10, preferably in the range from 7.5 to 9, and in particular in the range from 8 to 8.4.

The detergent preparation can be packaged as a portion unit. In addition to the detergent preparation, such a portion unit preferably comprises a water-soluble packaging film which completely encloses the detergent preparation.

Due to their high content of active substances and the low proportion of fillers and auxiliaries or solvents, the detergent preparation described above is particularly preferably packaged as a detergent supply form which, in addition to a detergent preparation, further comprises a container which contains a multiple of the quantity of the detergent preparation necessary for carrying out a washing process. The packaging as such a detergent supply form allows a significant reduction of the packaging means proportion per dosing unit compared to conventional, less concentrated detergent preparations and thus represents a resource-saving development of known detergent preparations. The high active substance concentration of the detergent preparation is associated with an advantageous dosing behavior, which also allows the simple and precise dosing of small volumes. It is therefore preferred if the container of the detergent supply form has a dosing opening.

The dosing opening preferably has an ellipsoid, particularly preferably a circular cross-sectional area. Preferred dosing openings can be closed by caps, in particular screw caps.

The materials known to a person skilled in the art are suitable for the production of the containers. The group of these materials includes, for example, plastics, in particular the thermoplastics polyethylene, polypropylene or polyethylene terephthalate.

Surprisingly, it has been found that the dosing behavior of the detergent preparation is influenced by means of the above-described containers by selecting the plastic used for producing the container. Thus, surfaces made of polyethylene have proven to be superior to identical surfaces made of polyethylene terephthalate with regard to the flow behavior of the detergent preparation. Furthermore, surfaces having a recycling component above 30 wt. % of identical surfaces of non-recycled polyethylene have proven to be superior with regard to the flow behavior of the detergent preparation. In summary, the flow behavior and the dosing accuracy of the detergent preparation from containers can be improved by the choice of the container material, wherein these advantages can be achieved in particular by selecting an advantageous container material in the region of the dosing opening of the container. For the aforementioned reasons, preferred containers in the region of the dosing opening are manufactured out of polyethylene, particularly preferably of polyethylene with a recycling component above 30 wt. %, in particular above 50 wt. %.

Containers for detergent compositions made of thermoplastics such as polyethylene are generally produced in one piece in forming processes such as blow molding. Container body and dosing opening are thus generally formed from the identical material. Against this background, it is preferred for the container in the region of the container body to be manufactured out of polyethylene, preferably polyethylene with a recycling component above 30 wt. %, in particular above 50 wt. %.

As an alternative to the thermoplastic plastics described above, in particular the polyethylene or recycled polyethylene, the containers for the detergent preparation are manufactured in a further preferred embodiment in part or completely out of fibers of plant origin. The use of corresponding packaging means not only reduces the ecological footprint of the supply form, but also favors their recyclability. Detergent supply forms in which the container is made of fibers of plant origin are therefore preferred.

The packaging of the detergent preparation by packaging means on the basis of fibers of plant origin is facilitated by a small proportion of aqueous or organic solvents. In order to improve the long-term stability of the container, however, it can be preferred to coat this container at least partially with a film-forming polymer, preferably a film-forming biopolymer. The container can be coated on one or both sides, i.e., on its inner side and its outside. Due to the higher stability of the coating, for example due to reduced mechanical damage to the coating due to handling or transporting of the container, and resulting from the increased stability of the container overall, the container is preferably coated on its inside with a film-forming polymer, preferably a film-forming biopolymer. Particularly preferred biopolymers are casein, alginate, carrageenan and pectin. The coating with biopolymers preferably has a thickness of 10 to 300 μm, in particular 20 to 200 μm.

The dosing of the detergent preparation from the container is facilitated by the use of elastically deformable containers. By varying the pressure acting on the container from the outside, both the dosing speed and the start of dosing and the dosing end can be determined by the user. Detergent supply forms in which the container is elastically deformable are preferred for this reason.

In summary, due to the advantageous properties of the detergent preparation, which can be further increased by the targeted selection of specific containers or container materials, the detergent supply form is particularly suitable for simple and precise dosing of individual portions by the consumer. This dosing can, for example, take place on a laundry item which is introduced subsequently into the interior of a textile washing machine. However, the use of a detergent supply form for dosing the detergent preparation into the receiving device of a textile washing machine is preferred. Preferred receiving devices are dosing caps, dosing balls, and particularly preferably the dosing drawer of the textile washing machine. The detergent supply form is particularly suitable for dosing small volumes, preferably volumes of 6 to 16 ml, in particular 8 to 14 ml of the detergent preparation.

As mentioned at the outset, the detergent composition is particularly suitable for cleaning textiles. This application also relates to a method for cleaning textiles, in which a previously described detergent preparation is introduced into the washing liquor of a textile washing machine. In preferred washing processes, an amount of 8 to 16 g, preferably 10 to 14 g of the detergent preparation is introduced into the washing liquor of a textile washing machine.

This application further relates to a method for producing the detergent preparation described above, comprising the steps in the following sequence:
i) providing a mixture of sodium-C₈₋₁₈-alkylbenzene sulfonate and non-ionic surfactant;
ii) adding C₈₋₁₈-alkylbenzene sulfonic acid and mixing the sulfonic acid-containing composition;
iii) adding alkanolamine and mixing the alkanolamine-containing composition;
iv) adding the enzyme preparation and mixing the enzyme-containing preparation.

To reduce or avoid gas inclusions in the detergent preparation, the mixture is subjected to a vacuum degassing in at least one of steps ii), iii) or iv), wherein the negative pressure used for vacuum degassing is less than 0.6 bar, preferably less than 0.4 bar, and in particular 0.1 to 0.3 bar.

To remove the heat of reaction, the mixture is preferably cooled in step iii). The cooling of the mixture also serves to increase the stability of the enzyme preparation added in the subsequent step iv). The mixture preferably has a temperature below 35° C., preferably below 30° C., when the enzyme preparation is added in step iv).

This application provides, inter alia, the following subjects:

1. A detergent preparation, comprising, based on the total weight thereof,
a) 20 to 50 wt. % anionic surfactant, comprising a mixture of alkanolamine-C8-18-alkylbenzene sulfonate and sodium-C₈₋₁₈-alkylbenzene sulfonate;
b) 20 to 40 wt. % non-ionic surfactant;
c) 0.2 to 12 wt. % enzyme preparation.

2. The detergent preparation according to point 1, wherein the detergent preparation contains, based on the total weight thereof, 24 to 45 wt. %, preferably 28 to 40 wt. % anionic surfactant, comprising alkanolamine-C₈₋₁₈-alkylbenzene sulfonate and sodium-C₈₋₁₈-alkylbenzene sulfonate.

3. The detergent preparation according to one of the preceding points, wherein the detergent preparation contains, in addition to the anionic surfactant from the group of alkanolamine-C₈₋₁₈-alkylbenzene sulfonates and sodium-C₈₋₁₈-alkylbenzene sulfonates, based on the total weight thereof, less than 10 wt. %, preferably less than 6 wt. %, in particular less than 2 wt. %, and in particular no further anionic surfactant(s).

4. The detergent preparation according to one of the preceding points, wherein the detergent preparation contains a mixture of alkanolamine-C₈₋₁₈-alkylbenzene sulfonate and sodium-C₈₋₁₈-alkylbenzene sulfonate in a weight ratio of from 10:1 to 1:4, preferably from 7:1 to 1:2, particularly preferably from 4:1 to 1:1, and in particular from 7:2 to 5:2.

5. The detergent preparation according to one of the preceding points, wherein the alkanolamine-C₈₋₁₈-alkylbenzene sulfonate comprises an alkanolamine from the group of monoethanolamine, monoisopropanolamine, diisopropanolamine, preferably from the group of monoisopropanolamine.

6. The detergent preparation according to one of the preceding points, wherein the detergent preparation contains, based on the total weight thereof, 4 to 18 wt. %, preferably 6 to 16 wt. %, fatty acid alkanolamine salt.

7. The detergent preparation according to point 6, wherein the fatty acid is selected from the group of myristic acid, palmitic acid, stearic acid, oleic acid, linoleic acid and mixtures thereof.

8. The detergent preparation according to one of points 6 or 7, wherein the fatty acid alkanolamine salt comprises an alkanolamine from the group of monoethanolamine, monoisopropanolamine, diisopropanolamine, preferably from the group of monoisopropanolamine.

9. The detergent preparation according to one of the preceding points, wherein the detergent preparation contains, based on the total weight thereof, 22 to 38 wt. %, preferably 24 to 36 wt. %, non-ionic surfactant.

10. The detergent preparation according to one of the preceding points, wherein the detergent preparation contains non-ionic surfactant from the group of the ethoxylated primary C₆₋₁₈ alcohols, preferably the ethoxylated primary C₆₋₁₈ alcohols having a degree of alkoxylation ≥2, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.

11. The detergent preparation according to one of the preceding points, wherein the detergent preparation contains anionic surfactant and non-ionic surfactant in a weight ratio of from 3:2 to 2:3, preferably from 4:3 to 1:1.

12. The detergent preparation according to one of the preceding points, wherein the detergent preparation contains, based on the total weight thereof, 0.5 to 10 wt. %, preferably 2 to 8 wt. %, enzyme preparation.

13. The detergent preparation according to one of the preceding points, wherein the detergent preparation contains at least one enzyme preparation, preferably at least 3 enzyme preparations of enzymes from the group of protease, amylase, mannanase, cellulase, lipase, β-hexosaminidase, preparations of a pectinolytic enzyme, and endoglucanase.

14. The detergent preparation according to one of the preceding points, wherein the detergent preparation contains, based on the total weight thereof, 0.5 to 7 wt. %, preferably 1 to 5 wt. %, of a protease preparation.

15. The detergent preparation according to one of the preceding points, wherein the detergent preparation contains, based on the total weight thereof, 0.05 to 2 wt. %, preferably 0.1 to 1 wt. %, of an amylase preparation.

16. The detergent preparation according to one of the preceding points, wherein the detergent preparation contains, based on the total weight thereof, 0.05 to 2 wt. %, preferably 0.1 to 1 wt. %, of a mannanase preparation.

17. The detergent preparation according to one of the preceding points, wherein the detergent preparation contains, based on the total weight thereof, 0.05 to 2 wt. %, preferably 0.1 to 1 wt. %, of a cellulase preparation.

18. The detergent preparation according to one of the preceding points, wherein the detergent preparation contains, based on the total weight thereof, 0.01 to 5 wt. %, preferably 0.1 to 4 wt. % and in particular 0.15 to 2.5 wt. %, hexosaminidase preparation.

19. The detergent preparation according to one of the preceding points, wherein the enzyme preparations, based on the total weight thereof, have a proportion by weight of active protein of 0.1 to 40 wt. %, preferably 0.2 to 30 wt. %.

20. The detergent preparation according to one of the preceding points, wherein the detergent preparation contains, based on the total weight thereof, less than 6 wt. %, preferably less than 4 wt. %, particularly preferably less than 1 wt. % and in particular no organic solvent.

21. The detergent preparation according to one of the preceding points, wherein the detergent preparation contains, based on the total weight thereof, less than 6 wt. %, preferably less than 3 wt. %, particularly preferably less than 1 wt. % and in particular no water.

22. The detergent preparation according to one of the preceding points, wherein the detergent preparation contains, based on the total weight thereof, 0.2 to 10 wt. %, preferably 0.5 to 8 wt. % and in particular 1.0 to 6 wt. % phosphonate.

23. The detergent preparation according to point 22, wherein the phosphonate is selected from the group of hydroxyalkane phosphonates and/or aminoalkane phosphonates, preferably from the group of aminoalkane phosphonates and in particular from the group of ethylenediamine tetramethylene phosphonate (EDTMP) and diethylenetriamine pentamethylene phosphonate (DTPMP), in particular from the group of diethylenetriamine pentamethylene phosphonate (DTPMP).

24. The detergent preparation according to one of the preceding points, wherein the detergent preparation contains, based on the total weight thereof, 1 to 18 wt. %, preferably 4 to 15 wt. %, washing-active polymer.

25. The detergent preparation according to one of the preceding points, wherein the detergent preparation contains washing-active polymer from the group of polyalkoxylated polyalkyleneimines which are obtained by reacting polyalkyleneimines with alkylene oxides.

26. The detergent preparation according to one of the preceding points, wherein the detergent preparation contains washing-active polymer from the group of polyalkoxylated polyethyleneimine.

27. The detergent preparation according to one of the preceding points, wherein the detergent preparation contains washing-active polymer from the group of polyalkoxylated amines having a weight-average molecular weight MW in the range from 600 g/mol to 10,000 g/mol, which are obtained by reacting ammonia or primary alkylamines or hydroxyalkylamines having a molecular weight of less than 200 g/mol with alkylene oxides.

28. The detergent preparation according to one of the preceding points, wherein the detergent preparation contains washing-active polymer from the group of polyalkoxylated amines of general formula (I),

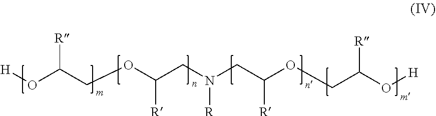

in which R represents a linear, in some cases branched or in some cases cyclic alkyl group having 1 to 12 C atoms, or a group —(CH₂CHR′O)_{n″}—(CH₂CHR″O)_{m″}—H,
R′ and R″ represent, independently of one another, H, CH₃ or CH₂CH₃,
n, n′ and n″ represent, independently of one another, numbers from 0 to 30, preferably from 0 to 10 and in particular 0 to 5, and
m, m′ and m″ represent, independently of one another, numbers from 0 to 30, preferably from 5 to 20 and in particular from 12 to 16,
with the proviso that the sum n+n′+n″+m+m′+m″ is at least 14, preferably in the range of from 18 to 100 and in particular in the range of from 20 to 70. Preferably, in the compounds of the formula I, at least one of the functional groups R′ and R″ is a CH₃ group.

29. The detergent preparation according to one of the preceding points, wherein the detergent preparation contains washing-active polymer from the group of polyalkoxylated amines, which are obtained by ethoxylation and subsequent propoxylation of triethanolamine.

30. The detergent preparation according to one of the preceding points, wherein the detergent preparation is washing-active polymer from the group of alcohol polyalkoxylates having a weight-average molecular weight MW in the range of from 600 g/mol to 10,000 g/mol, which are obtained by reacting diols or triols with primary and/or secondary OH groups, which have a molecular weight MW in the range from 60 g/mol to 200 g/mol, with alkylene oxides.

31. The detergent preparation according to one of the preceding points, wherein the detergent preparation contains washing-active polymer from the group of polypropylene glycols.

32. The detergent preparation according to one of the preceding points, wherein the detergent preparation contains washing-active polymer from the group of ethylene oxide propylene oxide ethylene oxide triblock copolymers, wherein the copolymer comprises a first EO block, a second EO block and a PO block, wherein the first EO block and the second EO block are connected to the PO block.

33. The detergent preparation according to one of the preceding points, wherein the detergent preparation contains, based on the total weight thereof, 0.2 to 4 wt. %, preferably 0.5 to 3 wt. %, fragrance preparation.

34. The detergent preparation according to one of the preceding points, wherein the detergent preparation contains, based on the total weight thereof, 0.01 to 0.2 wt. % dye.

35. The detergent preparation according to one of the preceding points, wherein the detergent preparation has a viscosity (23° C., shear rate 30 sec⁻¹) from 1,500 to 10,000 mPas, preferably from 3,000 to 8,000 mPas, particularly preferably from 5,500 to 6,500 mPas.

36. The detergent preparation according to one of the preceding points, wherein the detergent preparation has a pH from 6 to 10, preferably from 7.5 to 9 and in particular from 8 to 8.4.

37. The detergent preparation according to one of the preceding points, wherein the detergent preparation is packaged as a portion unit.

38. A detergent supply form, comprising
i) a detergent preparation according to one of points 1 to 36
ii) a container containing a multiple of the quantity of the detergent preparation necessary for carrying out a washing process.

39. The detergent supply form according to point 38, wherein the container has a dosing opening.

40. The detergent supply form according to one of points 38 or 39, wherein the container in the region of the dosing opening is manufactured out of polyethylene with a recycling component above 30 wt. %, preferably above 50 wt. %.

41. The detergent supply form according to one of points 38 to 40, wherein the container in the region of the container body is manufactured out of polyethylene with a recycling component above 30 wt. %, preferably above 50 wt. %.

42. The detergent supply form according to one of points 38 to 40, wherein the container is made of fibers of plant origin.

43. The detergent supply form according to point 42, wherein at least a portion of the container is coated with a film-forming polymer, preferably a film-forming biopolymer.

44. The detergent supply form according to one of points 42 or 43, wherein the container is coated on its inside with a film-forming polymer, preferably a film-forming biopolymer.

45. The detergent supply form according to one of points 38 to 44, wherein the container is elastically deformable.

46. A use of a detergent supply form according to one of points 38 to 45 for dosing the detergent preparation into the receiving device of a textile washing machine.

47. The use according to point 46, wherein the receiving device is selected from the group of dosing cap, dosing ball, and dosing drawer.

48. The use according to one of points 46 or 47, wherein 6 to 16 ml, preferably 8 to 14 ml, of the detergent preparation are dosed.

49. A method for cleaning textiles, in which a detergent preparation according to one of points 1 to 36 is introduced into the washing liquor of a textile washing machine.

50. The method according to point 49, wherein 8 to 16 g, preferably 10 to 14 g of the detergent preparation are introduced into the washing liquor of a textile washing machine.

51. The method for producing a detergent preparation according to one of points 1 to 36, comprising the steps in the following sequence:
i) providing a mixture of sodium-C₈₋₁₈-alkylbenzene sulfonate and non-ionic surfactant;
ii) adding C₈₋₁₈-alkylbenzene sulfonic acid and mixing the sulfonic acid-containing composition;
iii) adding alkanolamine and mixing the alkanolamine-containing composition;
iv) adding the enzyme preparation and mixing the enzyme-containing preparation.

52. The method according to claim 51, wherein the mixture is subjected to a vacuum degassing in at least one of steps ii), iii) or iv), wherein the negative pressure used for vacuum degassing is less than 0.6 bar, preferably less than 0.4 bar, and in particular 0.1 to 0.3 bar.

53. The method according to one of the points 51 or 52, wherein the mixture is cooled in step iii).

54. The method according to one of points 51 to 53, wherein the mixture, upon adding the enzyme preparation in step iv), has a temperature below 35° C., preferably below 30° C.

### EXAMPLES

The following detergent compositions were prepared by the following method:
i) providing a mixture of sodium-C₈₋₁₈-alkylbenzene sulfonate and non-ionic surfactant;
ii) adding C₈₋₁₈-alkylbenzene sulfonic acid and mixing the sulfonic acid-containing composition;
iii) adding alkanolamine and mixing the alkanolamine-containing composition;
iv) adding the enzyme preparation and the further constituents and re-mixing.

TABLE 1
detergent compositions (quantities in wt. %)

| | E1 | E2 | E3 |
|---|---|---|---|
| C₁₀₋₁₃ alkylbenzene sulfonic acid | 21.3 | 21.8 | 21.3 |
| sodium C₁₀₋₁₃ alkylbenzene sulfonate | 8.0 | 7.4 | 8.0 |
| C₁₂₋₁₈ fatty alcohol ethoxylate, 7 EO | 30 | 30 | 30 |
| C₁₂₋₁₈ fatty acid acid | 8.5 | 8.5 | 8.5 |
| monoisopronanolamine | 7.9 | 8.1 | 7.9 |
| DTPMP | — | 1.9 | 1.9 |
| polyalkoxylated polyalkyleneimine | — | 5.2 | 5.2 |
| polyalkoxylated amine | — | 5.9 | 5.9 |
| protease preparation | 4.0 | 3.5 | 3.5 |
| mannanase preparation | 0.3 | 0.7 | 0.7 |
| amylase preparation | 0.3 | 0.7 | 0.7 |
| cellulase preparation | 0.2 | — | — |
| β-hexosaminidase | — | 0.5 | 0.5 |
| Fragrance | — | 1.2 | 1.2 |
| Dye | — | 0.003 | 0.003 |
| Water | <1 | <1 | <1 |
| Misc. | up to 100 | up to 100 | up to 100 |
| pH | 8.3 | 8.2 | 8.2 |

The detergent compositions were optically, rheologically, and chemically stable during storage under stress conditions and were able to be dosed from storage containers with high accuracy.

In washing tests using 11 g of the corresponding detergent composition, they were characterized by a high cleaning capacity.

What is claimed is:

1. A detergent preparation, comprising, based on the total weight thereof,
i) 20 to 50 wt. % of an anionic surfactant, wherein the anionic surfactant comprises a mixture of alkanolamine-C₈₋₁₈-alkylbenzene sulfonate and sodium-C₈₋₁₈-alkylbenzene sulfonate;
ii) 20 to 40 wt. % of a non-ionic surfactant; and
iii) 0.2 to 12 wt. % of at least one enzyme preparation.

2. The detergent preparation according to claim 1, wherein the detergent preparation comprises, based on the total weight thereof, 24 to 45 wt. % of the anionic surfactant.

3. The detergent preparation according to claim 1, wherein the detergent preparation comprises, in addition to the anionic surfactant from the mixture of alkanolamine-C₈₋₁₈-alkylbenzene sulfonates and sodium-C₈₋₁₈-alkylbenzene sulfonates, based on the total weight thereof, less than 10 wt. % of other anionic surfactant(s).

4. The detergent preparation according to claim 1, wherein the detergent preparation comprises, in addition to the anionic surfactant from the group of alkanolamine-C₈₋₁₈-alkylbenzene sulfonates and sodium-C₈₋₁₈-alkylbenzene sulfonates, no further anionic surfactant(s).

5. The detergent preparation according to claim 1, wherein the detergent preparation comprises the mixture of alkanolamine-C₈₋₁₈-alkylbenzene sulfonate and sodium-C₈₋₁₈-alkylbenzene sulfonate in a weight ratio of from 10:1 to 1:4.

6. The detergent preparation according to claim 1, wherein the alkanolamine-C₈₋₁₈-alkylbenzene sulfonate is an alkanolamine selected from the group consisting of monoethanolamine, monoisopropanolamine and diisopropanolamine.

7. The detergent preparation according to claim 1, wherein the detergent preparation comprises, based on the total weight thereof, 0.5 to 10 wt. % of enzyme preparation.

8. The detergent preparation according to claim 1, wherein the at least one enzyme preparation is selected from the group consisting of protease, amylase, mannanase, cellulase, lipase, β-hexosaminidase, preparations of a pectinolytic enzyme, and endoglucanase.

9. A detergent supply form, comprising
i) a detergent preparation according to claim 1,
ii) a container containing one or more of the detergent preparation necessary for carrying out a washing process.

10. A method for producing a detergent preparation according to claim 1, comprising the steps in the following sequence:
i) providing a mixture of sodium-C₈₋₁₈-alkylbenzene sulfonate and non-ionic surfactant;
ii) adding the C₈₋₁₈-alkylbenzene sulfonic acid and mixing the resulting sulfonic acid-containing composition;
iii) adding alkanolamine and mixing the resulting alkanolamine-containing composition;
iv) adding the enzyme preparation and mixing the enzyme-containing preparation.

11. A method for cleaning textiles, in which a detergent preparation according to claim 1 is introduced into the washing liquor of a textile washing machine.
